(19) United States
(12) Patent Application Publication
(10) Pub. No.: US 2016/0381317 A1
(43) Pub. Date: Dec. 29, 2016

(54) DISPLAY DEVICE AND TELEVISION RECEIVING DEVICE

(71) Applicant: SHARP KABUSHIKI KAISHA, Osaka (JP)

(72) Inventor: Mitsuru HOSOKI, Osaka (JP)

(73) Assignee: Sharp Kabushiki Kaisha, Osaka (JP)

(21) Appl. No.: 15/125,120

(22) PCT Filed: Feb. 19, 2015
(86) PCT No.: PCT/JP2015/054551

§ 371 Date: Sep. 9, 2016

(30) Foreign Application Priority Data
Mar. 19, 2014 (JP) 2014-056070

(51) Int. Cl. H04N 5/64; F21V 8/00; G02F 1/1343; G02F 1/1333; G02F 1/1335

(52) U.S. Cl. CPC H04N 5/64; G02F 1/133305; G02F 1/1336; G02F 1/134309; G02F 1/133308; G02B 6/0068; G02B 6/009; G02B 6/0088; G02B 6/0083; G02B 6/0085; G02F 1/1368

(57) ABSTRACT

A liquid crystal display device includes: a chassis having a bottom plate; a liquid crystal panel; source-side flexible substrates bent such that one end side thereof is connected to the liquid crystal panel and another end side thereof reaches a rear surface side of the bottom plate; a source substrate connected to the other end side of the source-side flexible substrates and disposed on the rear surface side of the bottom plate; a light guide plate, an end face thereof that faces toward the source-side flexible substrates being a first light-receiving face, and another end face thereof being a second light-receiving face; first LEDs that are of a top-emitting type and that are disposed so as to face the first light-receiving face; second LEDs that are of a side-emitting type and are disposed so as to face the second light-receiving face; a metal first LED substrate, the first LEDs being disposed on a surface thereof; and a second LED substrate, the second LEDs being disposed on a surface thereof.

### TECHNICAL FIELD

The present invention relates to a display device and a television receiver.

### BACKGROUND ART

A liquid crystal display device such as a liquid crystal television requires a separate backlight device as an illumination device since the liquid crystal panel, which is a display panel, does not emit light on its own, for example. LEDs, for example, are well-known as a light source used in such a backlight device. LEDs are broadly divided into a top-emitting type in which the surface opposite to the mounting surface to be mounted on a mounting substrate is the primary light-emitting surface, and a side-emitting type in which one of the side faces disposed upright on the mounting surface to be mounted on the mounting substrate is the primary light-emitting surface. Patent Document 1, for example, discloses a backlight unit that includes both such top-emitting LEDs and such side-emitting LEDs.

Backlight devices are broadly categorized into direct-lit and edge-lit types, depending on the configuration thereof. The backlight unit disclosed in Patent Document 1 is of the direct-lit type. In order to make the liquid crystal display device thinner, however, it is preferable to use a so-called “edge-lit backlight device” in which light from light sources disposed so as to face an end face of a light guide plate enters the end face of the light guide plate and then exits toward a display panel from one of the surfaces of the light guide plate.

When using LEDs as the light sources in an edge-lit backlight device, it is preferable to use top-emitting LEDs instead of side-emitting LEDs in order to ensure a high degree of brightness. In general, top-emitting LEDs have a higher rated value for forward current compared to side-emitting LEDs, and the amount of light emitted from the light-emitting surface is higher in top-emitting LEDs than in side-emitting LEDs. In addition, it is preferable to use a metal LED substrate instead of a non-metal LED substrate in order to ensure heat-dissipating characteristics. This is due to the fact that, while in side-emitting LEDs the surface to the rear of the light-emitting surface is not directly soldered onto the LED, top-emitting LEDs are disposed such that the surface to the rear of the light-emitting surface is attached to the LED substrate via direct soldering or the like; thus, heat is more effectively transmitted from the LEDs to the LED substrate in top-emitting LEDs than in side-emitting LEDs. As mentioned above, it is preferable in edge-lit backlight devices to use top-emitting LEDs disposed on a metal LED substrate in order to ensure a high degree of brightness and heat-dissipating characteristics.

### RELATED ART DOCUMENT

### Patent Document

Patent Document 1: Japanese Patent No. 5173998

### Problems to be Solved by the Invention

In recent years, demand has increased for high-resolution liquid crystal panels and for liquid crystal panels with high color reproducibility. High-resolution liquid crystal panels include a large amount of wiring within the liquid crystal panel in order to increase the number of pixels, and liquid crystal panels with high color reproducibility require that color filters that form part of the liquid crystal panel be thicker in order to increase color purity; thus, transmittance in these types of liquid crystal panels is lower than in normal liquid crystal panels. As a result, there is demand to increase the brightness of the light emitted from the light sources toward the liquid crystal panel.

Thus, by disposing top-emitting LEDs, which are disposed in the above-described manner on a metal LED substrate, so as to face a plurality of end faces of the light guide plate, it is possible to increase the brightness of the light emitted from the light sources toward the liquid crystal panel while ensuring heat-dissipating characteristics. In an edge-lit backlight device, a mounting substrate on which the top-emitting LEDs are arranged is disposed in a vertical orientation inside a chassis. In addition, wiring patterns can be provided on only one surface of the metal mounting substrate, and the size of the surface of the mounting substrate is larger than in a case in which the mounting substrate is not made of metal. As a result, the display device is thicker in the area in which the top-emitting LEDs disposed on the metal LED substrate are arranged. Thus, when the top-emitting LEDs disposed on the metal LED substrate are disposed so as to face a plurality of end faces of the light guide plate, the respective areas where the LEDs are disposed become thicker, leading to the display device becoming thicker as a whole.

### SUMMARY OF THE INVENTION

The technology disclosed in the present specification was made in view of the above-mentioned problems, and an aim thereof is to make a display device thinner while ensuring a high degree of brightness and heat-dissipating characteristics.

### Means for Solving the Problems

The technology disclosed in the present specification relates to a display device that includes: a chassis having at least a bottom plate; a display panel disposed on one surface side of the bottom plate; a flexible substrate that is flexible and bent such that one end side thereof is connected to the display panel and another end side reaches another surface side of the bottom plate; a signal transmission substrate that is connected to said another end side of the flexible substrate and disposed on said another surface side of the bottom plate, the signal transmission substrate transmitting signals to the flexible substrate; a light guide plate that is disposed between the display panel and the bottom plate and that emits light toward the display panel, an end face of the light guide plate facing the flexible substrate being a first light-receiving face and at least one other end face of the light guide plate being a second light-receiving face; first light sources of a top-emitting type disposed such that a light-emitting surface thereof faces the first light-receiving face of the light guide plate; second light sources of a side-emitting type disposed such that a light-emitting surface thereof faces the second light-receiving face of the light guide plate; a first light source substrate made of metal and supported by the bottom plate of the chassis, the first light sources being disposed on a surface of the first light source substrate; and a second light source substrate supported by the bottom plate of the chassis, the second light sources being disposed on a surface of the second light source substrate.

According to the above-described display device, the first light sources are of a top-emitting type and light enters at least two of the end faces of the light guide plate; thus, it is possible to increase the brightness of light exiting from the light guide plate toward the display panel compared to a configuration in which all of the light sources are of a side-emitting type or a configuration in which light is received at only one end face of the light guide plate. In addition, according to the above-described display device, while heat becomes concentrated in the area in which the signal transmission substrate is disposed as a result of heat generated by the first light sources and heat generated by a driving component that drives the display panel by processing signals from the signal transmission substrate, or the like, for example, the heat from the first light sources is effectively transmitted to the first light source substrate by having the first light sources be of the top-emitting type. Furthermore, by having the first light source substrate be made of metal and be supported by the bottom plate, it is possible to effectively transmit the heat generated by the first light sources and the driving component from the first light source substrate toward the bottom plate compared to a case in which the first light source substrate is not made of metal, and it is also possible to then dissipate the heat toward the outside of the display device.

Furthermore, the above-described display device is of a so-called “edge-lit” type in which light enters end faces of the light guide plate; thus, the first light source substrate is supported in a vertical orientation by the bottom plate since the first light sources are of the top-emitting type, and the second light source substrate is supported in a horizontal orientation by the bottom plate since the second light sources are of the side-emitting type. In addition, the first light source substrate is made of metal; thus, wiring patterns can be provided on only one surface of the first light source substrate and the size of the surface thereof will be larger than in a case in which the mounting substrate is not made of metal. Thus, the space in the thickness direction of the display device necessary to dispose the first light source substrate is larger than the space necessary to dispose the second light source substrate. Here, in the display device, a surface of the bottom plate of the chassis that is opposite to the side to which the light guide plate is disposed, or in other words, the above-mentioned other surface, is a surface that faces toward the exterior of the chassis. In addition, the signal transmission substrate is disposed on the other surface side of the bottom plate of the chassis; thus, the display device is thicker in the area in which the signal transmission substrate is disposed.

Thus, in the above-described display device, the first light source substrate is disposed in an area in which the display device is thicker as a result of the signal transmission substrate being disposed in the above-described manner; thus, it is possible for a thickness based on the arrangement of the signal transmission substrate to limit the effect of the disposition of the first light source substrate on the thickness of the display device. Meanwhile, in the area in which the second light source substrate is disposed, the display device will not become thicker since the second light source substrate is disposed horizontally in the above-described manner. Thus, it is possible for the display device as a whole to be made thinner. In the above-mentioned display device, it is possible in the manner described above to make the display device thinner while ensuring a high degree of brightness and heat-dissipating characteristics.

The first light sources may have a higher output than the second light sources. In the present specification, “higher output” refers to the driving power of the first light sources being higher than the driving power of the second light sources, and the amount of the light emitted from the first light sources being larger than the amount of light emitted from the second light sources.

Since the first light sources are of the top-emitting type and the first light source substrate is made of metal, even if the first light sources have a higher output, heat generated by the first light sources will be effectively transmitted to the first light source substrate and then transmitted to the bottom plate via the first light source substrate. Thus, it is possible to prevent heat buildup near the first light sources. According to the above-mentioned configuration, it is possible to increase the amount of light emitted from the first light sources while also ensuring heat-dissipating characteristics. By so doing, it is also possible to increase the brightness of light emitted from the light guide plate toward the display panel.

The first light source substrate may be disposed such that a portion thereof overlaps the signal transmission substrate in a direction orthogonal to the first light-receiving face.

According to such a configuration, it is possible to make the display device thinner in the area in which the signal transmission substrate and the first light source substrate are disposed.

The second light source substrate may be made of a flexible resin.

According to such a configuration, the second light source substrate can be made thinner compared to an instance in which the second light source substrate is made of a metal, and it is also possible to make the display device thinner in the area in which the second light source substrate is disposed.

At least a portion of the second light source substrate may be attached to a surface of the light guide plate such that the portion is sandwiched between the light guide plate and the bottom plate.

According to such a configuration, it is possible to use the second light source substrate to position the light guide plate with respect to the bottom plate.

A positioning portion that positions the light guide plate with respect to the bottom plate may be provided on an edge of the light guide plate near the first light-receiving face. In addition, a positioning portion that positions the light guide plate with respect to the first light source substrate may be provided on an edge of the light guide plate near the first light-receiving face.

According to such a configuration, it is possible to position the light guide plate with respect to the bottom plate at both the first light source side and the second light source side, and it is also possible to accurately position the light guide plate with respect to the bottom plate.

A pair of opposing end faces of the light guide plate may respectively be the first light-receiving face and the second light-receiving face, and the second light source substrate may have an abutting portion that abuts an end face of the light guide plate adjacent to the second light-receiving face, the abutting portion extending toward the first light source substrate from an end of the second light source substrate.

Since the second light source substrate is flexible, it is possible to have abutting portions abut the pair of opposing end faces of the light guide plate by folding the abutting portions. According to the above-mentioned configuration, it is possible to have the pair of opposing end faces of the light guide plate be sandwiched by the abutting portions, and it is possible to position the light guide plate with respect to the second light source substrate.

In such a configuration, light that reaches the abutting portions is reflected by the abutting portions; thus, it is possible to prevent light from leaking from the end faces adjacent to the second light-receiving face of the light guide plate.

The display device may further include a light source driving substrate that is disposed on said another surface side of the bottom plate and that provides driving power to the first light sources and the second light sources, a first wiring line may be connected to the first light source substrate, another end of the first wiring line being connected to the light source driving substrate, and a second wiring line may be connected to the abutting portion of the second light source substrate, another end of the second wiring line being connected to the light source driving substrate.

In such a configuration, as a result of the second wiring line being connected to the abutting portion that extends from the second substrate, it is possible to connect the first wiring line and the second wiring line to the light source driving substrate by drawing out both wiring lines to the other surface side of the bottom plate together. Thus, it is possible to easily draw out the wiring for driving the light sources.

The first wiring line and the second wiring line may be connected to the light source driving substrate via the signal transmission substrate.

In such a configuration, it is possible to shorten the drawn-out length of the first wiring line and the second wiring line compared to a configuration in which the first wiring line and the second wiring line are drawn out all the way to the light source driving substrate, and it is thus possible to simply draw out the respective wiring lines.

The chassis may have a side wall that rises from an edge of the bottom plate toward the display panel, and the display device may further include a first heat-dissipating member that contacts the first light source substrate and the side wall while being sandwiched therebetween.

In such a configuration, heat that was transmitted to the first light source substrate is transmitted toward the bottom plate of the chassis and is also transmitted toward the side wall of the chassis via the first heat-dissipating member; thus, it is possible to increase the heat-dissipating characteristics from the first light source substrate toward the chassis.

The display device may further include a second heat-dissipating member that contacts the bottom plate and the signal transmission substrate while being sandwiched therebetween.

In such a configuration, the heat transmitted toward the chassis from the first light sources and the heat generated by the signal transmission substrate can be effectively dissipated to the outside of the display device via the second heat-dissipating member.

In the technology disclosed in the present specification, a display device in which the display panel is a liquid crystal panel that uses liquid crystal is also novel and useful. Furthermore, a television receiver that includes the above-described display device is also novel and useful.

### Effects of the Invention

An aim of the technology disclosed in the present specification is to make a display device thinner while ensuring a high degree of brightness and heat-dissipating characteristics.

### BRIEF DESCRIPTION OF THE DRAWINGS

FIG. 1 is an exploded perspective view that shows a schematic configuration of a television receiver according to Embodiment 1.

FIG. 2 is an exploded perspective view that shows a schematic configuration of a liquid crystal display device.

FIG. 3 is a cross-sectional view showing a cross-section of a liquid crystal display device along the short-side direction thereof.

FIG. 4 is a cross-sectional view that magnifies the side of FIG. 3 in which a source substrate is disposed.

FIG. 5 is a cross-sectional view that magnifies the side of FIG. 3 in which the source substrate is not disposed.

FIG. 6 is a plan view from the front side of a liquid crystal panel.

FIG. 7 is a plan view as seen from the front side of a chassis, light guide plate, and respective LED units.

FIG. 8 is a plan view of a modification example as seen from the front side of a chassis, light guide plate, and respective LED units.

FIG. 9 is a perspective view of Embodiment 2 before a chassis, light guide plate, and respective LED units are attached.

FIG. 10 is a perspective view after the chassis, light guide plate, and respective LED units have been attached.

FIG. 11 is a plan view as seen from the rear side of the chassis, light guide plate, and respective LED units.

FIG. 12 is a plan view of a modification example as seen from the rear side of a chassis, light guide plate, and respective LED units.

FIG. 13 is an exploded perspective view that shows a schematic configuration of a liquid crystal display device according to Embodiment 3.

### DETAILED DESCRIPTION OF EMBODIMENTS

### Embodiment 1

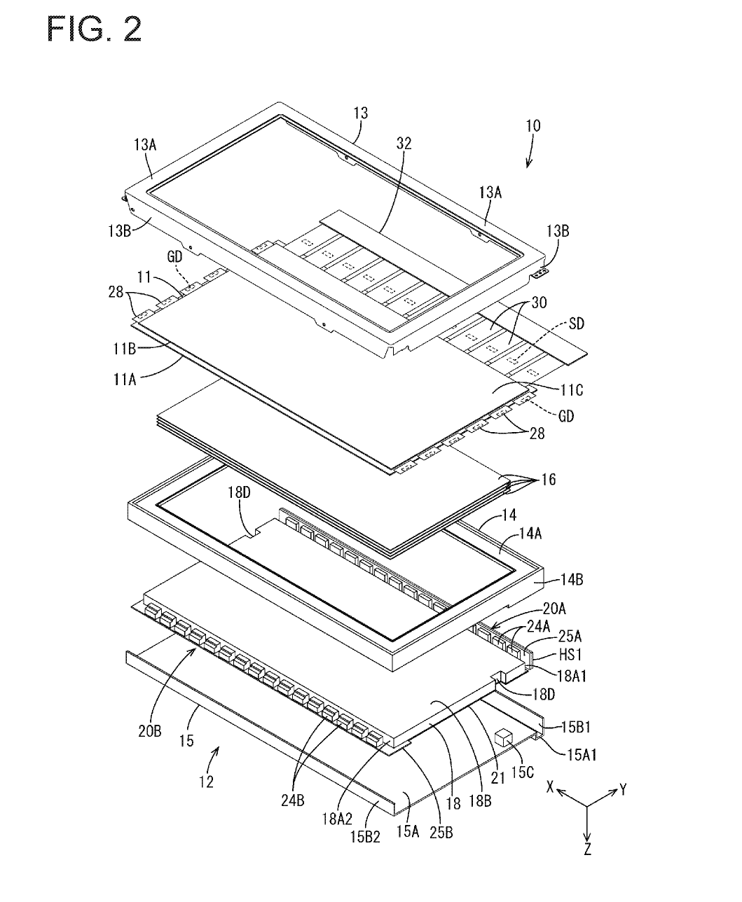

Embodiment 1 will be described with reference to the drawings. In the present embodiment, a liquid crystal display device (one example of a display device) 10 will be described as an example. Each of the drawings indicates an X axis, a Y axis, and a Z axis in a portion of the drawings, and each of the axes indicates the same direction in the respective drawings. The X axis direction corresponds to the horizontal direction, the Y axis direction corresponds to the vertical direction, and the Z axis direction corresponds to the thickness direction (front-rear direction). In FIG. 2, the top side of the paper corresponds to the front side of the liquid crystal display device 10, and the bottom side of the paper corresponds to the rear side of the liquid crystal display device 10.

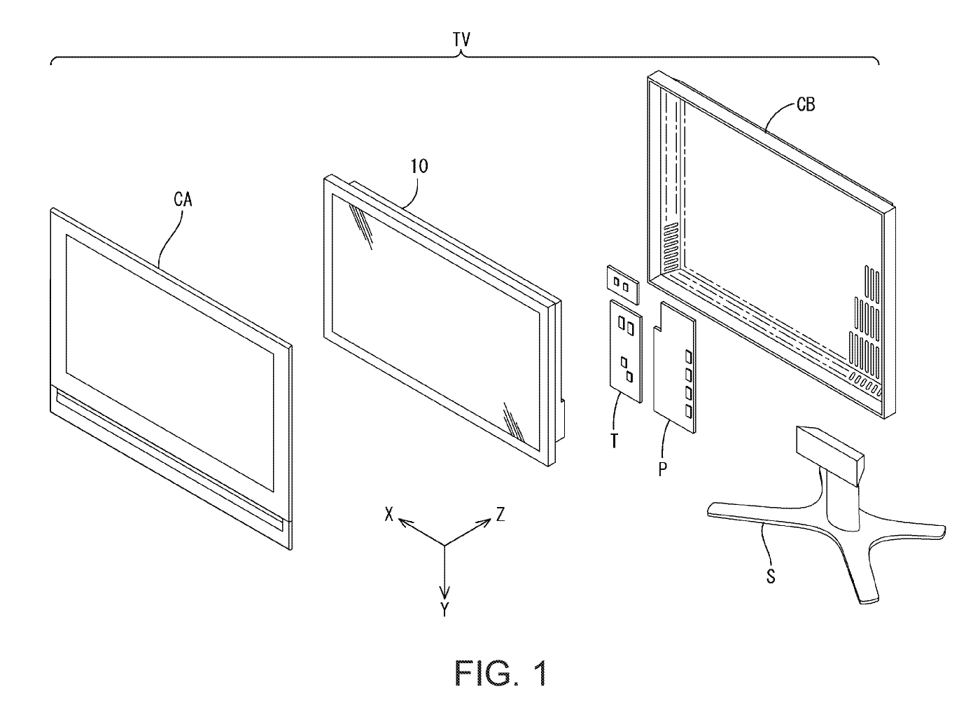

A television receiver TV includes: the liquid crystal display device 10; front and rear cabinets CA, CB that house the liquid crystal display device 10 therebetween; a power source P; a tuner T; and a stand S. The liquid crystal display device 10 has a horizontally-long quadrangular shape as a whole, and includes a liquid crystal panel 11 that is a display panel, and a backlight device 12 that is an external light source. These are integrally held together by a component such as a bezel 13 having a frame-like shape. In the liquid crystal display device 10, the liquid crystal panel 11 is assembled with a display surface 11C, which is capable of displaying images, facing toward the front. As shown in FIG. 1, the liquid crystal display device 10 is configured such that, when vertically-oriented, the thickness near the lower edge is thicker than that of other sections. The liquid crystal panel 11 of the present embodiment is a high-resolution liquid crystal panel that includes a large number of pixels.

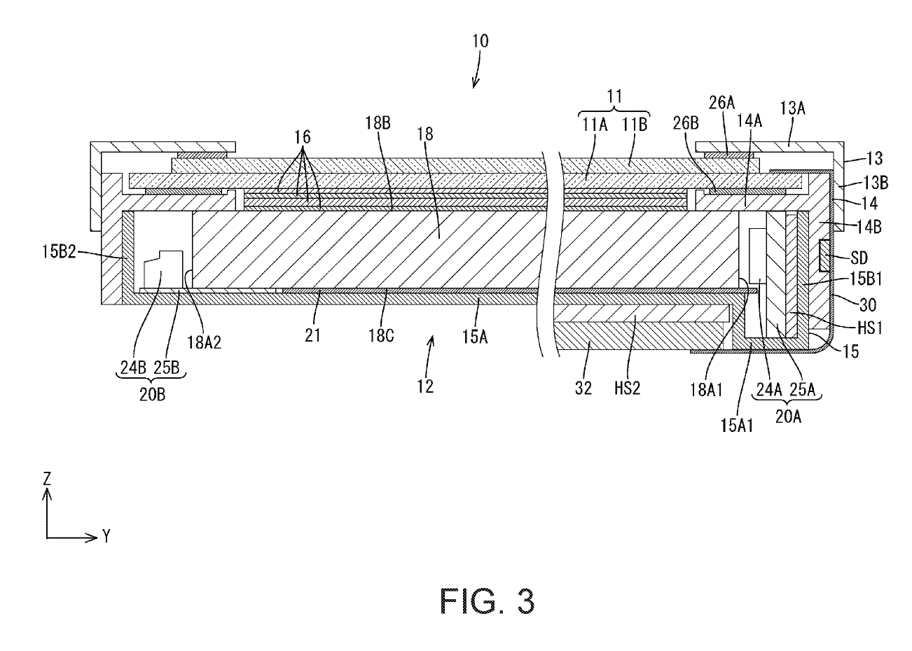

The bezel 13 is made of a metal with excellent rigidity such as stainless steel, and, as shown in FIGS. 2 and 3, is formed of a bezel frame section 13A that is parallel to the liquid crystal panel 11 and that has a substantially frame-like shape in a plan view, and a bezel cylindrical section 13B that extends in a substantially short tube-like shape from the peripheral edges of the bezel frame section 13A toward the rear. The bezel frame section 13A extends along the edges of the display surface 11C of the liquid crystal panel 11. Cushioning material 26A is disposed between the bezel frame section 13A and the liquid crystal panel 11. The bezel frame section 13A holds the liquid crystal panel 11 by pressing upon the edges of the display surface 11C from the front through the cushioning material 26A. The bezel cylindrical section 13B covers a portion of a frame 14, which will be described later, and forms a portion of the exterior of the side faces of the liquid crystal display device 10.

The configuration of the backlight device 12 will be explained next. As shown in FIG. 2, the main constituting components of the backlight device 12 are housed within a space between the frame 14 that forms the front exterior of the backlight device 12, and a chassis 15 that forms the rear exterior of the backlight device 12. The main constituting components housed between the frame 14 and the chassis 15 at least include: a light guide plate 18; a reflective sheet 21; a first LED unit 20A, and a second LED unit 20B. Optical sheets 16 are disposed on the front side of the light guide plate 18. The light guide plate 18 is held between the frame 14 and the chassis 15 so as to be sandwiched therebetween, and the optical sheets 16 and the liquid crystal panel 11 are stacked on the front side of the light guide plate 18 in that order. The first LED unit 20A and the second LED unit 20B face each other in the space between the frame 14 and the chassis 15 so as to sandwich the light guide plate 18 in the short-side direction from both sides. Thus, the backlight device 12 of the present embodiment is of a so-called “edge-lit” type. Each of the various constituting components of the backlight device 12 will be described below.

The light guide plate 18 is made of a synthetic resin material (an acrylic resin such as PMMA, or a polycarbonate, for example) that has a refractive index sufficiently higher than that of air and that is almost completely transparent (has excellent light transmissivity). As shown in FIG. 2, the light guide plate 18 has a horizontally-long quadrangular shape in a plan view that is similar to the shape of the liquid crystal panel 11 and the optical sheets 16, which will be described later. The long-side direction of the surface of the light guide plate 18 corresponds to the X axis direction, the short-side direction thereof corresponds to the Y axis direction, respectively, and a thickness direction that is orthogonal to the surface corresponds to the Z axis direction. The light guide plate 18 is supported by the chassis 15, which will be described later.

One of the two long-side end faces of the light guide plate 18 is a first light-receiving face 18A1 that receives light emitted from the first LED unit 20A, and the other of the two long-side end faces is a second light-receiving face 18A2 that receives light emitted from the second LED unit 20B. Of these, the first light-receiving face 18A1 faces toward the side of the liquid crystal display device 10 on which source-side flexible substrates 30, which will be described later, are disposed. The light guide plate 18 is disposed such that: the pair of light-receiving faces 18A1, 18A2 respectively face the respective LED units 20A, 20B; a light-exiting surface 18B, which is the main surface (front surface), faces toward the optical sheets 16; and an opposite surface 18C, which is the surface (rear surface) on the side opposite of the light-exiting surface 18B, faces toward the reflective sheet 21. A light guide plate 18 with such a configuration receives light emitted from the respective LED units 20A, 20B at the respective light-receiving faces 18A1, 18A2, propagates the light therein, orients the light upward toward the optical sheets 16, and then emits the light from the light-exiting surface 18B.

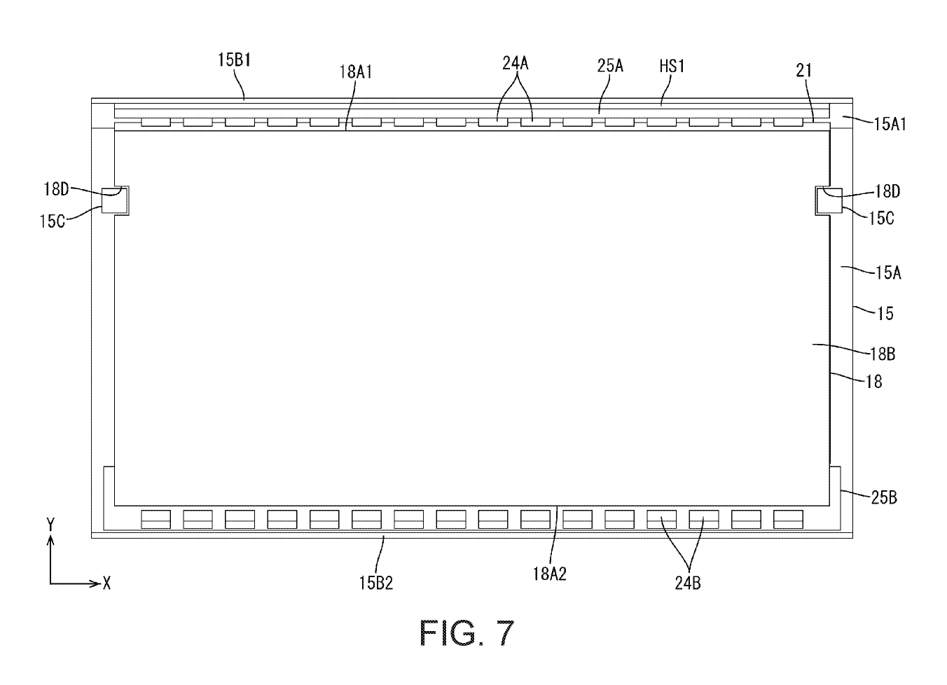

Cutout portions (one example of a positioning portion) 18D, which have a recessed shape and respectively recede toward the inside (the center of the light guide plate 18), are provided in both short-side end faces of the light guide plate 18 near the first light-receiving face 18A1 edge of each short-side end face. As shown in FIG. 7, the respective cutout portions 18D are provided so as to pass through the light guide plate 18 in the thickness direction (Z axis direction) thereof so as to have a rectangular shape in a plan view. The locations of the respective cutout portions 18D match each other in the short-side direction (Y axis direction) of the light guide plate 18.

The reflective sheet 21 is a rectangular sheet-shaped member, is made of a synthetic resin, and the front surface thereof is white with excellent light-reflecting characteristics. The long-side direction of the reflective sheet 21 corresponds to the X axis direction, the short-side direction thereof corresponds to the Y axis direction, and the reflective sheet 21 contacts the light guide plate 18 and the chassis 15 while being sandwiched therebetween. The reflective sheet 21 is able to reflect light that has leaked from the respective LED units 20A, 20B or the light guide plate 18 toward the front surface of the reflective sheet 21. As shown in FIG. 3, of the two long-side edges of the reflective sheet 21, the edge facing the first LED unit 20A protrudes slightly beyond the first light-receiving face 18A1 of the light guide plate 18, and the edge facing the second LED unit 20B is located to the inside (toward the center of the light guide plate 18) of the second light-receiving face 18A2 of the light guide plate 18.

As shown in FIG. 2, the optical sheets 16 have a horizontally-long quadrangular shape in a plan view similar to that of the light guide plate 18 and the liquid crystal panel 11, and the size thereof (long-side dimensions and short-side dimensions) in a plan view is slightly smaller than that of the light guide plate 18 and the light-exiting surface 18B of the liquid crystal panel 11. The optical sheets 16 are stacked on the light-exiting surface 18B of the light guide plate 18, and contact the light guide plate 18 and the liquid crystal panel 11 while being sandwiched therebetween. The optical sheets 16 are formed of four stacked sheet-shaped sheet members. Specific examples of the type of sheets that can be used as the optical sheets 16 include diffusion sheets, lens sheets, reflective polarizing sheets, and the like. It is possible to appropriately select and use any of the above-mentioned sheets as the optical sheets 16. The optical sheets 16 are disposed so as to be interposed between the liquid crystal panel 11 and the light guide plate 18, thereby transmitting the light emitted from the light guide plate 18, imparting prescribed optical effects on this transmitted light, and emitting this light toward the liquid crystal panel 11.

The chassis 15 forms the rear exterior of the liquid crystal display device 10. The chassis 15 is made of a metal such as aluminum, and as shown in FIG. 2, has a substantially shallow-plate shape that is horizontally long as a whole so as to cover almost the entire rear side of the liquid crystal display device 10. The chassis 15 is formed of a bottom plate 15A that covers the rear side of the liquid crystal panel 11, a first side wall 15B1 that rises toward the front from one long-side edge of the bottom plate 15A, and a second side wall 15B2 that rises toward the front from the other long-side edge of the bottom plate 15A. Also, of the two long-side edges of the bottom plate 15A, the edge on the first side wall 15B1 side is a stepped portion 15A1 that forms a step that protrudes from the bottom plate 15A toward the rear of the liquid crystal display device 10 (see FIG. 3). As shown in FIG. 3, the rising dimension (Z axis direction dimension) of the first side wall 15B1 is substantially equal to the dimension of the thickness dimension of the light guide plate 18 plus the dimension to which the stepped portion 15A1 protrudes, and the first side wall 15B1 covers the entire rear surface side (the side opposite to the light-emitting side of the first LEDs 24A) of the first LED unit 20A. Meanwhile, as shown in FIG. 3, the rising dimension (Z axis direction dimension) of the second side wall 15B2 is substantially equal to the thickness dimension of the light guide plate 18, and the second side wall 15B2 covers the entire rear surface side (the side opposite to the light-emitting side of the second LEDs 24B) of the second LED unit 20A.

As shown in FIGS. 2 and 7, protrusions 15C, which protrude toward the front (toward the liquid crystal panel 11), are respectively provided on both long-side direction ends of the bottom plate 15A in locations near the stepped portion 15A1. The locations of the respective protrusions 15C match each other in the short-side direction (Y axis direction) of the bottom plate 15A, and the protrusions 15C protrude in a block shape perpendicular to (along the Z axis direction) the bottom plate 15A so as to be symmetric about the light guide plate 18. In the plan view shown in FIG. 7, approximately half of each of the protrusions 15C is housed within the respective cutout portions 18D provided in the light guide plate 18 such that there is almost no gap between the protrusion 15C and the cutout portion 18D. As a result, the respective protrusions 15C engage the respective cutout portions 18D, and the light guide plate 18 and the bottom plate 15A are locked together via the protrusions 15C. In this manner, by having the respective protrusions 15C engage the respective cutout portions 18D, the light guide plate 18 is positioned with respect to the bottom plate 15A.

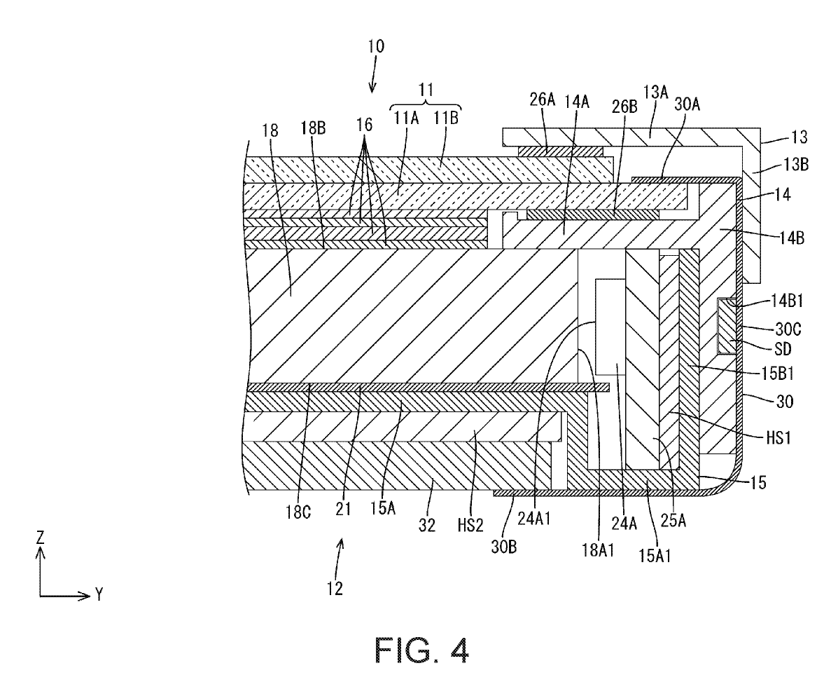

As shown in FIG. 2, the first LED unit 20A is disposed along the long-side direction of the light guide plate 18, and the lengthwise direction dimension of the first LED unit 20A is substantially the same as the long-side dimension of the light guide plate 18. The first LED unit 20A is formed of first LEDs (one example of a first light source) 24A, and a first LED substrate (one example of a first light source substrate) 25A. Each of the first LEDs 24A that forms a portion of the first LED unit 20A is formed by using a resin material to seal an LED chip (not shown) on a substrate section that is fixed to the first LED substrate 25A. The LED chip mounted on the substrate section has one primary light-emitting wavelength, and specifically, emits only blue light. Meanwhile, a phosphor that emits a prescribed color when excited by blue light emitted from the LED chip is dispersed within the resin material that seals the LED chip. Thus, the LED as a whole emits light that is largely white. For the phosphor, a yellow phosphor that emits yellow light, a green phosphor that emits green light, and a red phosphor that emits red light can be appropriately combined, or only one of the phosphors can be used, for example. The first LEDs 24A are the so-called top-emitting type, in which the light-emitting surface 24A1 is the surface opposite to the mounting surface to be mounted on the LED substrate 25A (the surface facing the first light-receiving face 18A1 of the light guide plate 18; see FIG. 4).

The first LED substrate 25A forming part of the first LED unit 20A is made of aluminum that has excellent heat-dissipating characteristics, and as shown in FIG. 2, has an elongated plate-like shape that extends along the long-side direction (X axis direction) of the light guide plate 18, and is supported in a vertical orientation by the stepped portion 15A1 of the bottom plate 15A of the chassis 15. Specifically, the first LED substrate 25A is disposed such that the surface thereof is parallel to the X axis direction and the Z axis direction, or in other words, is disposed such that the surface thereof is parallel to the first light-receiving face 18A1 of the light guide plate 18. The long-side direction (X axis direction) dimension of the first LED substrate 25A is substantially equal to the long-side direction (X axis direction) dimension of the light guide plate 18 (see FIG. 7), and the short-side direction (Z axis direction) dimension thereof is substantially equal to the dimension of the thickness dimension of the light guide plate 18 plus the dimension to which the stepped portion 15A1 protrudes (see FIG. 3).

On the inner surface of the first LED substrate 25A, or in other words, on the surface facing the light guide plate 18 (the face opposing the light guide plate 18), the first LEDs 24A having the configuration described above are surface-mounted, and this surface is considered to be the mounting surface. The respective first LEDs 24A are directly soldered onto the mounting surface of the first LED substrate 25A such that the light-emitting surface 24A1 thereof faces the light-receiving face 18A1 of the light guide plate 18. A plurality of the first LEDs 24A are disposed in a row (a straight line) at substantially the same pitch along the lengthwise direction (X axis direction) of the mounting surface of the first LED substrate 25A. A wiring pattern (not shown) made of a metal film (such as copper foil) is formed on the mounting surface of the first LED substrate 25A. The wiring pattern extends along the X axis direction and connects adjacent first LEDs 24A in series by going across the group of first LEDs 24A. Driving power is provided to the first LEDs 24A by having terminals formed at both ends of the wiring pattern be connected to an LED driving substrate (not shown) via a wiring member such as a connector or electric wiring. As shown in FIG. 3, a sheet-shaped first heat dissipation sheet (one example of a first heat-dissipating member) HS1 that has heat-dissipating characteristics is disposed between the first LED substrate 25A and the first side wall 15B1 of the chassis 15. The first heat dissipation sheet HS1 contacts the first LED substrate 25A and the first side wall 15B1 between the first LED substrate 25A and the first side wall 15B1. As a result, a portion of the heat transmitted to the first LED substrate 25A is effectively transmitted to the first side wall 15B1 via the first heat dissipation sheet HS1.

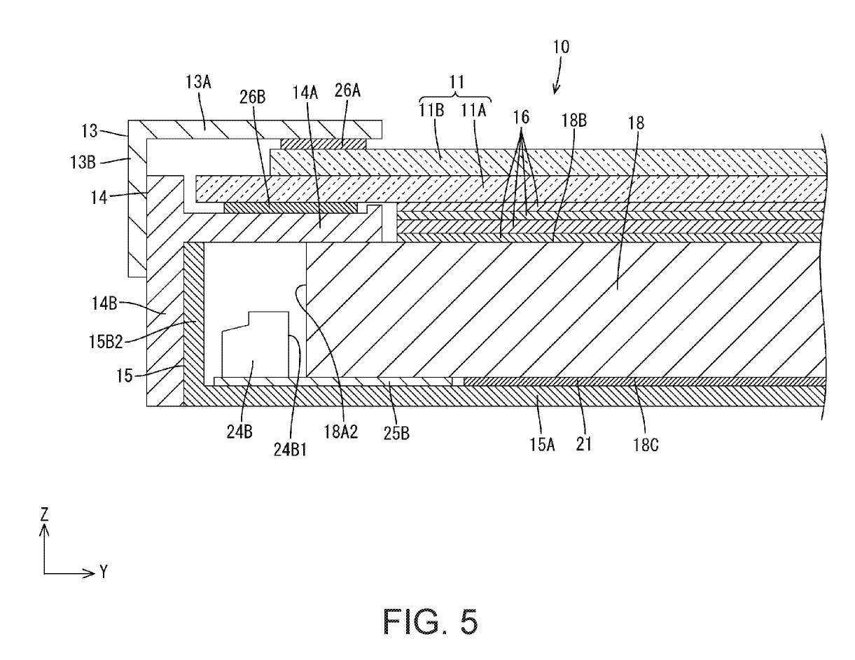

As shown in FIG. 2, the second LED unit 20B is disposed along the long-side direction of the light guide plate 18, and the lengthwise direction dimension thereof is slightly larger than the long-side dimension of the light guide plate 18. The second LED unit 20B is formed of second LEDs (one example of a second light source) 24B, and a second LED substrate (one example of a second light source substrate) 25B. Each of the second LEDs 24B that forms part of the second LED unit 20B is formed by using a resin material to seal an LED chip (not shown) that is disposed upright on the second LED substrate 25B. The primary light-emitting wavelength of the LED chip and the configuration of the resin material are the same as those of the first LEDs 24A. The second LEDs 24B are of the so-called “side-emitting type”, in which one of the side faces is the light-emitting surface 24B1 when a face disposed upright on the second LED substrate 25B is the front surface (or the rear surface; see FIG. 5). The first LEDs 24A have a higher output than the second LEDs 24B. Specifically, the driving power of the first LEDs 24A is higher than the driving power of the second LEDs 24B, and the amount of light emitted from the first LEDs 24A is larger than the amount of light emitted from the second LEDs 24B.

The second LED substrate 25B that forms part of the second LED unit 20B is formed of a synthetic resin material (a polyimide resin or the like, for example) that has insulating properties, is formed via a flexible film-shaped base material, and is disposed close to the second light-receiving face 18A2 edge of the light guide plate 18. The second LED substrate 25B has a horizontally-long rectangular shape in a plan view, and is supported in a horizontal orientation by the bottom plate 15A of the chassis 15. Specifically, the second LED substrate 25B is disposed such that the long-side direction thereof corresponds to the X axis direction and the short-side direction thereof corresponds to the Y axis direction. The front surface of the second LED substrate 25B is the face that faces the liquid crystal panel 11 (faces toward the front) and is the face on which the second LEDs 24B are disposed upright. The rear surface of the second LED substrate 25B faces toward the bottom plate 15A of the chassis 15. Approximately half of the second LED substrate 25B that is closer to the inside in the short-side direction thereof (the part closer to the center of the light guide plate 18) contacts the bottom plate 15A of the chassis 15 and the edge of the opposite surface 18C of the light guide plate 18 that is closer to the second light-receiving face 18A2 while being sandwiched therebetween. The approximately half of the second LED substrate 25B that contacts the light guide plate 18 is attached to the opposite surface 18C of the light guide plate 18 via adhesive tape or the like (not shown). In order to improve the reflection efficiency of the second LED substrate 25B, a white resist may be formed on the front surface of the second LED substrate 25B.

A plurality of the second LEDs 24B disposed upright on the front surface of the second LED substrate 25B are disposed in parallel along the long-side direction (X axis direction) of the second LED substrate 25B. The respective second LEDs 24B are disposed upright on the front surface of the second LED substrate 25B via an LED attachment member (not shown) such that the light-emitting surface 24B1 thereof faces the second light-receiving face 18A2 of the light guide plate 18. Wiring lines are connected to a portion of the two long-side ends of the second LED substrate 25B at a tip thereof. By having the other end of the wiring lines be electrically connected to an LED driving substrate or the like (not shown), power is provided to the second LEDs 24B and the driving of the second LEDs 24B is controlled.

The frame 14 is formed in a horizontally-long frame-like shape similar to the shape of the bezel 13 and is made of a synthetic resin (a polycarbonate or polyethylene terephthalate, for example). The frame 14 is formed of a frame framing section 14A that is parallel to the liquid crystal panel 11 and that has a substantially frame-like shape in a plan view, and frame cylindrical sections 14B that respectively extend in a substantially short-tube like shape from the peripheral edges of the frame framing section 14A toward the front and rear sides. The frame framing section 14A extends along the edges of the light-exiting surface 18B of the light guide plate 18, and sandwiches the light guide plate 18 between the bottom plate 15A of the chassis 15 and the frame framing section 14A by pressing upon the edges of the light-exiting surface 18B from the front. Cushioning material 26B is disposed between the frame framing section 14A and the liquid crystal panel 11. The frame framing section 14A supports the edges of the liquid crystal panel 11 from the rear via the cushioning material 26B. The length of the portion of the frame cylindrical section 14B that extends toward the rear from the peripheral edges of the frame framing section 14A is longer than the length of the portion that extends toward the front. The portion that extends toward the rear forms a portion of the exterior of the side faces of the liquid crystal display device 10 by being provided on a large portion of the first side wall 15B1 and second side wall 15B2 of the chassis 15. In addition, a recessed driver housing section 14B1 is provided in the portion of the frame cylindrical section 14B provided on the first side wall 15B1. The recessed driver housing section 14B1 opens toward the outside (the side opposite to the side that is next to the first side wall 15B1) and houses a source driver SD, which will be explained later (see FIG. 4).

The configuration of the liquid crystal panel 11 will be explained next. As shown in FIGS. 2 and 3, the liquid crystal panel 11 has a horizontally-long quadrangular shape in a plan view, and is stacked on the optical sheets 16. The liquid crystal panel 11 has a configuration in which glass substrates 11A, 11B having excellent light transmissivity are bonded to each other with a prescribed gap therebetween while having liquid crystal sealed between the two substrates 11A, 11B. Of the pair of substrates 11A, 11B, the substrate on the front side is a CF substrate 11B, and the substrate on the rear side is an array substrate 11A. On the array substrate 11A, switching elements (TFTs, for example) connected to source wiring lines and gate wiring lines that are orthogonal to each other, pixel electrodes connected to the switching elements, an alignment film, and the like are provided. Specifically, a plurality of TFTs and pixel electrodes are arranged on the array substrate 11A, and a plurality of gate wiring lines and source wiring lines are arranged in a grid pattern around the TFTs and pixel electrodes so as to surround the TFTs and the pixel electrodes. The gate wiring lines and the source wiring lines are respectively connected to a gate electrode and a source electrode, and the pixel electrode is connected to a drain electrode of the TFT.

Capacitance wiring lines (auxiliary capacitance wiring lines, storage capacitance wiring lines) that are parallel to the gate wiring lines and overlap the pixel electrodes in a plan view are provided on the array substrate 11A. The capacitance wiring lines and the gate wiring lines are alternately arranged in a line along the Y axis direction. Meanwhile, the following are provided on the CF substrate 11B: color filters having respective colored portions such as R (red), G (green), and B (blue) arranged in a prescribed pattern, an opposite electrode, an alignment film, and the like. This liquid crystal panel 11 is divided into a display region that is provided toward the center of the screen of the display surface 11C and that can display images, and a non-display region that is located at the peripheral edges of the screen covered by the bezel frame section 13A of the bezel 13 and that forms a frame-like shape that surrounds the display region. Polarizing plates (not shown) are disposed to the outside of both substrates 11A, 11B.

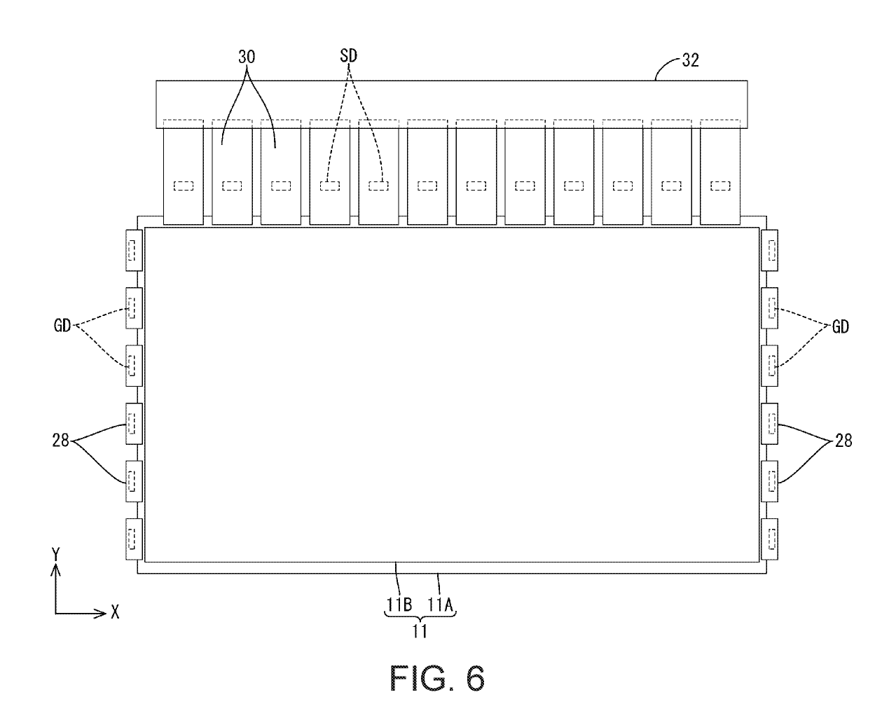

As shown in FIGS. 3 and 6, the array substrate 11A, which is one of the pair of substrates 11A, 11B forming the liquid crystal panel 11, is formed slightly larger than the CF substrate 11B such that the peripheral edges thereof protrude beyond the peripheral edges of the CF substrate 11B along the entire periphery thereof. A plurality of gate-side terminals (not shown), which are drawn out from the gate wiring lines and the capacitance wiring lines described above, are provided on both short-side edges that form part of the peripheral edges of the array substrate 11A. Gate-side flexible substrates 28 that are flexible are connected to the various gate-side terminals. A plurality (six on each side in the present embodiment) of the gate-side flexible substrates 28 are arranged along the Y axis direction, or in other words, in the direction along the short-side edges of the array substrate 11A, with gaps provided at substantially equal intervals therebetween. The plurality of gate-side flexible substrates 28 extend toward the outside from the short-side edges of the array substrate 11A. Meanwhile, a plurality of source-side terminals (not shown), which are drawn out from the source wiring lines, are provided on one long-side edge (the right side of the paper in FIG. 3, the top side of the paper in FIG. 6) of the two long-side edges forming part of the peripheral edges of the array substrate 11A. Source-side flexible substrates (one example of a flexible substrate) 30 that are flexible are connected to the source-side terminals. A plurality (twelve in the present embodiment) of the source-side flexible substrates 30 are arranged along the X axis direction, or in other words, in the direction along a long-side edge of the array substrate 11A, with gaps provided at substantially equal intervals therebetween. The plurality of source-side flexible substrates 30 extend toward the outside from the long-side edge of the array substrate 11A.

As shown in FIGS. 3 and 6, the gate-side flexible substrates 28 and the source-side flexible substrates 30 are respectively formed in a film shape and formed of a synthetic resin material (a polyimide resin, for example) that has insulating and flexible characteristics. A gate driver GD for driving liquid crystal is mounted on the rear surface of the gate-side flexible substrate 28, and a source driver SD is mounted on the rear surface of the source-side flexible substrate 30. The gate driver GD and the source driver SD have a horizontally-long protrusion-like shape that protrudes inward from the mounting surface thereof. The gate driver GD and the source driver SD are respectively formed of a LSI chip that has an internal driver circuit. The gate driver GD and the source driver SD generate output signals by processing input signals associated with images provided from a control substrate (not shown), which is the signal source, and then outputs these output signals to the liquid crystal panel 11.

The length of the source-side flexible substrate 30 extending from the array substrate 11A of the liquid crystal panel 11 is longer than that of the gate-side flexible substrate 28. As shown in FIG. 4, the source-side flexible substrate 30 extends in the thickness direction (Z axis direction) of the liquid crystal display device 10 from the portion of the array substrate 11A that overlaps the stepped portion 15A1 of the bottom plate 15A of the chassis 15. The source-side flexible substrate 30 is also drawn out by being bent such that a side (other end side) 30B opposite to one end side 30A connected to the liquid crystal panel 11 reaches the rear surface side of the bottom plate 15A of the chassis 15, thereby sandwiching the first side wall 15B1 of the chassis 15. Specifically, the source-side flexible substrate 30 is drawn out such that the other end side reaches the rear surface side of the border between the stepped portion 15A1 and the portion of the bottom plate 15A of the chassis 15 that supports the light guide plate 18.

A source substrate (one example of a signal transmission substrate) 32 is disposed on a portion of the rear surface side of the bottom plate 15A of the chassis 15 (see FIG. 4). The one end side 30A of the source-side flexible substrate 30 is crimp-connected to the source-side terminal of the array substrate 11A, and the other end side 30B thereof is crimp-connected to the source substrate 32, via anisotropic conductive films (ACF), respectively. Therefore, the source substrate 32 is disposed on the rear surface side of the bottom plate 15A of the chassis 15 near the border between the stepped portion 15A1 and the portion of the bottom plate 15A of the chassis 15 that supports the light guide plate 18. Put another way, the source substrate 32 is disposed on the rear surface side of the bottom plate 15A, and is disposed at a location so as to overlap, in the thickness direction (Z axis direction) of the liquid crystal display device 10, a portion of the light guide plate 18 near the end face on which the first light-receiving face 18A1 is provided. In addition, as shown in FIG. 3, by disposing the source substrate 32 in such a manner, a portion of the first LED substrate 25A housed in the stepped portion 15A1 overlaps the source substrate 32 in a direction (Y axis direction) that is orthogonal to the first light-receiving face 18A1.

A plurality of wiring patterns (not shown) are formed on an inward-facing (facing toward the chassis 15) surface of the source-side flexible substrate 30. One end of these wiring patterns is connected to the source-side terminals of the liquid crystal panel 11, and the other end is connected to the source substrate 32. The source-side flexible substrate 30 is of a one surface-mounting type in which the wiring patterns and the source driver SD are selectively mounted on only one surface. On the inner surface of the source-side flexible substrate 30, an insulating film is formed so as to cover a large portion of the wiring pattern (except for both ends), thereby insulating the wiring patterns.

A portion (a middle portion) of the wiring pattern between the one end and the other end is connected the source driver SD mounted on the inner surface of the source-side flexible substrate 30. As shown in FIG. 4, the source driver SD is disposed such that the entirety thereof is housed within the driver housing section 14B1 provided in the frame cylindrical section 14B of the frame 14. The source driver SD is housed within the driver housing section 14B1 such that a small gap is provided between the driver housing section 14B1 and the source driver SD, resulting in the source driver SD not making contact with the driver housing section 14B1. Thus, the source driver SD does not interfere with the frame cylindrical section 14B of the frame 14, and a mounting portion 30C of the source-side flexible substrate 30 on which the source driver SD is mounted is stopped or prevented from bending as a result of the source driver SD interfering with the frame cylindrical section 14B. As a result, nearly the entire portion of the inner surface of the source-side flexible substrate 30 that faces the frame cylindrical section 14B of the frame 14 contacts the outer surface of the frame cylindrical section 14B.

In addition, by having the source driver SD not contact the driver housing section 14B1 in this manner, a large portion of the heat generated in the source driver SD when the source driver SD is driven is transmitted to the mounting portion 30C of the source-side flexible substrate 30 on which the source driver SD is mounted. As shown in FIG. 4, the mounting portion 30C is exposed to the outside of the liquid crystal display device 10; thus, heat transmitted from the source driver SD to the mounting portion 30C is then dissipated to the outside of the liquid crystal display device 10 from the mounting portion 30C.

As shown in FIG. 6, the source substrate 32 has an elongated shape along the X axis direction. The source substrate 32 is disposed in a location near the stepped portion 15A1 of the bottom plate 15A, the surface thereof being parallel to the X axis direction and Y axis direction, or in other words, parallel to the bottom plate 15A of the chassis 15 (see FIG. 4). The source substrate 32 includes a plate-shaped base material made of a synthetic resin. Metal wiring lines are patterned onto the base material, and a terminal connected to at least a portion of the metal wiring lines is connected to the source-side flexible substrate 30. The rear surface of the source substrate 32 is located at approximately the same height (a location in the Z axis direction) as the rear surface of the stepped portion 15A1 of the bottom plate 15A of the chassis 15. FIG. 6 shows the source-side flexible substrates 30 before being bent.

As shown in FIG. 4, a sheet-shaped second heat dissipation sheet (one example of a second heat-dissipating member) HS2 that has heat-dissipating characteristics is disposed between the bottom plate 15A of the chassis 15 and the source substrate 32. The second heat dissipation sheet HS2 contacts both the bottom plate 15A of the chassis 15 and the source substrate 32 while being sandwiched therebetween. As a result, the entire space formed between the source substrate 32 and the bottom plate 15A of the chassis 15 is filled by the second heat dissipation sheet HS2. Thus, heat transmitted from the first LED substrate 25A to the bottom plate 15A of the chassis 15 is effectively transmitted from the bottom plate 15A to the source substrate 32 via the second heat dissipation sheet HS2. The above-described first heat dissipation sheet HS1 and the second heat dissipation sheet HS2 are made of graphite, for example. The sheet surfaces of both heat dissipation sheets are adhesive, and the heat dissipation sheets are disposed so as to be respectively bonded to both members that sandwich the sheet. As a result, positional deviation of the respective heat dissipation sheets HS1, HS2 is prevented. The thickness of the respective heat dissipation sheets HS1, HS2 can be appropriately modified in accordance with the thickness, arrangement, or the like, of the source substrate 32, the first LED substrate 25A, or the like. In addition, by using a sheet with insulating properties as the second heat dissipation sheet HS2, it is possible to prevent or suppress short-circuits and the like from the source substrate 32.

In the liquid crystal display device 10 of the present embodiment that has the above-mentioned configuration, light is received at two end faces (the first light-receiving face 18A1 and the second light-receiving face 18A2) of the light guide plate 18; thus, it is possible to increase the brightness of light emitted from the light guide plate 18 toward the liquid crystal panel 11 compared to a configuration in which light is received at only one end face of the light guide plate 18. In addition, the first LEDs 24A are of the top-emitting type; thus, the amount of light received by the light guide plate 18 is higher than in a configuration in which all of the LEDs are of the side-emitting type, and it is possible to increase the brightness of light emitted from the light guide plate 18 toward the liquid crystal panel 11 compared to a configuration in which light is received at only one end face of the light guide plate 18.

In addition, in the liquid crystal display device 10 of the present embodiment, heat becomes concentrated in the area in which the source substrate 32 is disposed, or in other words, near the first light-receiving face 18A1 of the light guide plate 18, as a result of heat generated by the first LEDs 24A and heat generated by the source driver SD. As a countermeasure, in the present embodiment, the first LEDs 24A are of the top-emitting type; thus, the first LEDs 24A are directly soldered onto the first LED substrate 25A, and the contact area between the LEDs and the LED substrate is larger than in a configuration in which the first LEDs 24A are of the side-emitting type. Thus, heat is effectively transmitted from the first LEDs 24A to the first LED substrate. Furthermore, the first LED substrate 25A is made of aluminum and is supported by the bottom plate 15A of the chassis 15; thus, it is possible for heat generated by the first LEDs 24A to be effectively transmitted from the first LED substrate 25A toward the bottom plate 15A compared to a case in which the first LED substrate 25A is not made of metal. As a result, in the liquid crystal display device 10 of the present embodiment, it is possible to effectively dissipate heat that becomes concentrated near the first light-receiving face 18A1 as a result of the addition of heat generated by the source driver SD, with the heat being effectively dissipated to the outside of the liquid crystal display device 10 via the bottom plate 15A of the chassis 15.

Furthermore, the liquid crystal display device 10 of the present embodiment is configured to include an edge-lit backlight device 12; thus, the first LED substrate 25A is supported in a vertical orientation by the bottom plate 15A of the chassis 15 since the first LEDs 24A are of the top-emitting type, and the second LED substrate 25B is supported in a horizontal orientation by the bottom plate 15A of the chassis 15 since the second LEDs 24B are of the side-emitting type. In addition, the first LED substrate 25A is made of aluminum, or in other words, made of metal; thus, wiring patterns can be provided on just one surface of the first LED substrate 25A, and the size of the surface of the first LED substrate 25A is larger than in a case in which the first LED substrate 25A is not made of metal. Thus, the space in the thickness direction (Z axis direction) of the liquid crystal display device 10 necessary to dispose the first LED substrate 25A is larger than the space necessary to dispose the second LED substrate 25B.

The source substrate 32 is disposed on the rear surface side of the bottom plate 15A of the chassis 15; thus, the thickness (the dimension in the Z axis direction) of the liquid crystal display device 10 is larger in the area where the source substrate 32 is disposed (the area near the first light-receiving face 18A1). As a countermeasure, in the liquid crystal display device 10 of the present embodiment, the first LED substrate 25A is disposed in the area in which the liquid crystal display device 10 is thicker as a result of the source substrate 32 being disposed in the above-described manner. Thus, having the thickness based on the disposition of the source substrate 32 makes it possible to limit the effect of the disposition of the first LED substrate 25A on the thickness of the liquid crystal display device 10. Meanwhile, in the area in which the second LED substrate 25B is disposed, the liquid crystal display device 10 will not become thicker since the second LED substrate 25B is disposed horizontally in the above-described manner. Thus, it is possible to make the liquid crystal display device 10 thinner overall.

In the liquid crystal display device 10 of the present embodiment described above, it is possible to increase the brightness of light emitted from the light guide plate 18 toward the liquid crystal panel 11; thus, it is possible to realize a higher degree of brightness even when the liquid crystal panel 11 is a high-resolution liquid crystal panel as in the present embodiment. In addition, even in a configuration such as that of the present embodiment in which heat becomes concentrated in the area in which the source substrate 32 is disposed as a result of LEDs being disposed in the same area, it is possible to effectively dissipate heat to the outside of the liquid crystal display device 10 in the above-described manner. Furthermore, in the liquid crystal display device 10 of the present embodiment, it is possible to prevent the liquid crystal display device 10 from becoming thicker in areas (such as the area where the second LED substrate 25B is disposed) other than the area where the source substrate 32 is disposed, while also limiting the effect of the disposition of the first LED substrate 25A on the thickness of the liquid crystal display device 10 in the area in which the source substrate 32 is disposed. As a result, in the liquid crystal display device 10 of the present embodiment, it is possible to make the liquid crystal display device 10 thinner while ensuring heat-dissipating characteristics and a high degree of brightness.

In addition, in the liquid crystal display device 10 of the present embodiment, the first LEDs 24A have a higher output than the second LEDs 24B. In other words, the driving power of the first LEDs 24A is larger than the driving power of the second LEDs 24B, and the amount of light emitted from the first LEDs 24A is larger than the amount of light emitted from the second LEDs 24B. Also, since the first LEDs 24A are of the top-emitting type and the first LED substrate 25A is made of aluminum, even if the first LEDs 24A have a higher output as described above, heat generated by the first LEDs 24A will be effectively transmitted to the first LED substrate 25A and then transmitted to the bottom plate 15A of the chassis 15 via the first LED substrate 25A. Thus, it is possible to prevent heat buildup near the first LEDs 24A. In this manner, it is possible to increase the amount of light emitted from the first LEDs 24A while also ensuring heat-dissipating characteristics. By so doing, it is also possible to increase the brightness of light emitted from the light guide plate 18 toward the liquid crystal panel 11.

In addition, in the liquid crystal display device 10 of the present embodiment, a portion of the first LED substrate 25A is disposed so as to overlap the source substrate 32 in a direction (the Y axis direction) orthogonal to the first light-receiving face 18A1. By using such a configuration, it is possible to make the liquid crystal display device 10 thinner in the area in which the source substrate 32 and the first LED substrate 25A are disposed.

In addition, in the liquid crystal display device 10 of the present embodiment, the second LED substrate 25B is made of a flexible synthetic resin. As a result, there is a degree of freedom in regards to the drawing-out configuration of the wiring lines, such as using multiple layers of wiring lines, and there is also a degree of freedom with respect to the shape of the second LED substrate 25B; thus, by doing things such as making the reflective sheet 21 and the second LED substrate 25B have the same thickness, it is possible to make the liquid crystal display device 10 even thinner in the area in which the second LED substrate 25B is disposed.

In addition, in the liquid crystal display device 10 of the present embodiment, the light guide plate 18 is positioned with respect to the bottom plate 15A by having the respective protrusions 15C engage the respective cutout portions 18D near the first light-receiving face, and the light guide plate 18 is also positioned with respect to the bottom plate 15A via the second LED substrate 25B by having a portion of the second LED substrate 25B be attached to the opposite surface 18C of the light guide plate 18 near the second light-receiving face. By using such a configuration, it is possible to more accurately position the light guide plate 18 with respect to the bottom plate 15A compared to configuration in which only a central portion of the light guide plate 18 is positioned with respect to the bottom plate 15A, for example.

### Modification Example of Embodiment 1

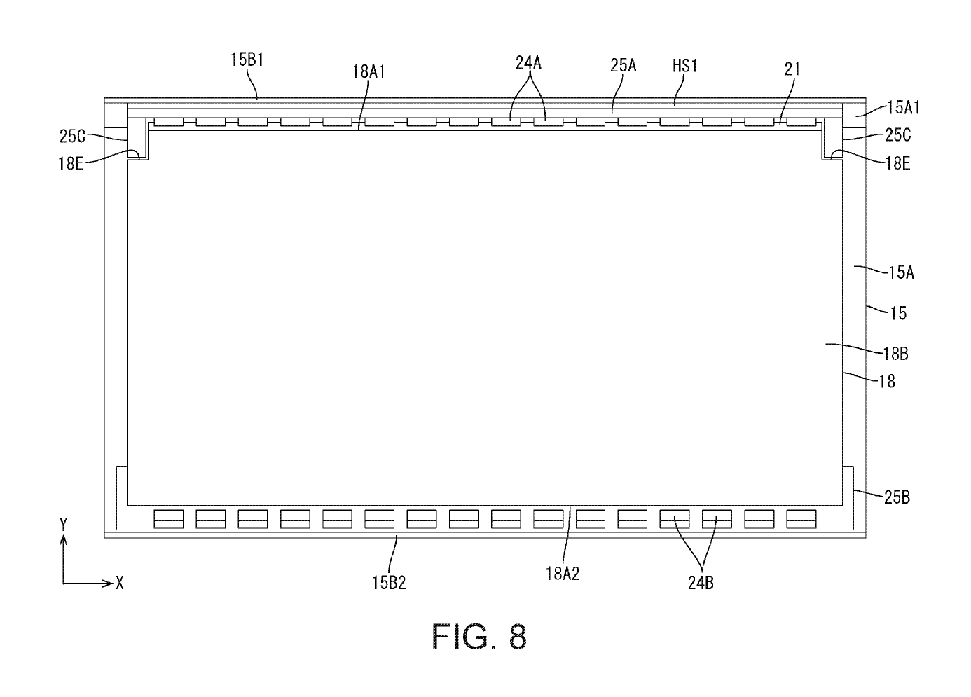

Next, a modification example of Embodiment 1 will be described with reference to FIG. 8. In the present modification example, the positioning configuration of the light guide plate 18 differs from Embodiment 1. As shown in FIG. 8, in the present modification example, cutout portions 18E are respectively provided in, from among the four corners of the light guide plate, the corners located at both ends of the first light-receiving face 18A1 in the long-side direction (X axis direction) of the light guide plate 18. The respective cutout portions 18E are provided so as to pass through the light guide plate 18 in the thickness direction (Z axis direction) thereof so as to have a rectangular shape in a plan view. Meanwhile, on the first LED substrate 25A, protrusions 25C that protrude toward the first light-receiving face 18A1 are respectively provided at both ends of the mounting surface for the first LEDs 24A in the long-side direction (X axis direction) thereof. The protrusions 25C protrude in a block shape perpendicular to (along the Y axis direction) the mounting surface for the first LEDs 24A.

In the plan view shown in FIG. 8, a large portion of each of the protrusions 25C provided on the first LED substrate 25A fits into the respective cutout portions 18E provided in the light guide plate 18 such that there is almost no gap between the protrusion 25C and the cutout portion 18E. As a result, the respective protrusions 25C engage the respective cutout portions 18E, and the light guide plate 18 and the first LED substrate 25A are locked together via the protrusions 25C. In this manner, by having the respective protrusions 25C engage the respective cutout portions 18E, the light guide plate 18 is positioned with respect to the first LED substrate 25A. Even in such a configuration, by having a portion of the second LED substrate 25B be attached to the opposite surface 18C of the light guide plate 18, the light guide plate 18 is positioned at both respective ends in the short-side direction (Y axis direction) thereof. Thus, it is possible to effectively position the light guide plate 18 compared to a configuration in which only a central portion of the light guide plate 18 is positioned with respect to the bottom plate 15A.

### Embodiment 2

Embodiment 2 will be described with reference to the drawings. Embodiment 2 differs from Embodiment 1 in that the configuration of the second LED substrate 125B and the drawing-out configuration of the various wiring lines that connect the respective LED substrates 125A, 125B to the LED driving substrate 134 are different. Other configurations are similar to those of Embodiment 1; thus, descriptions of the configurations, operation, and effects thereof are omitted.

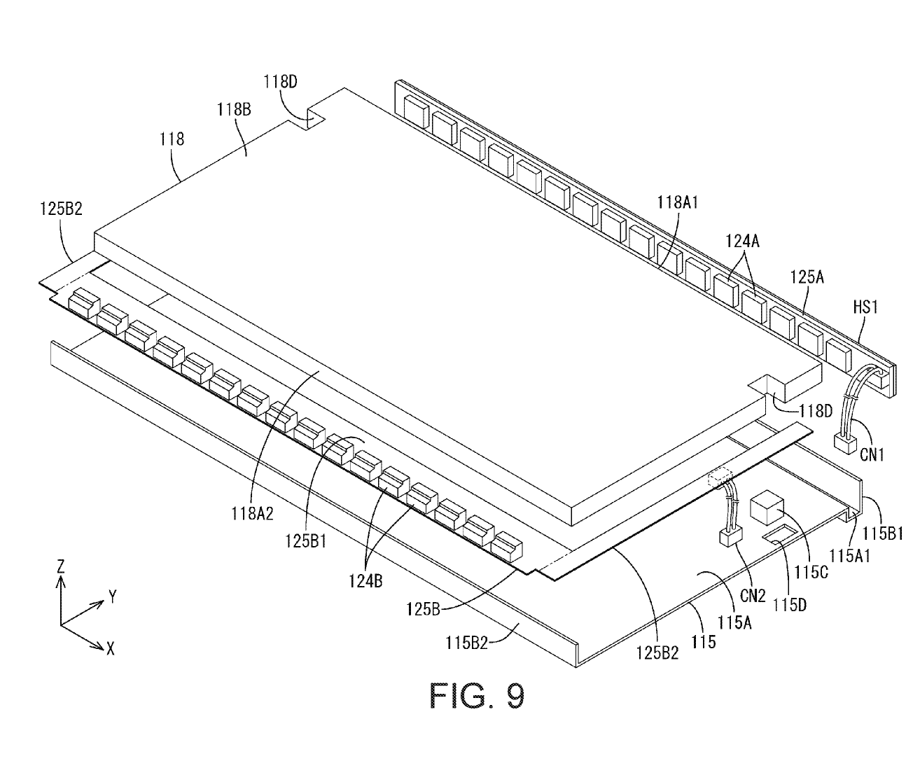

As shown in FIG. 9, a liquid crystal display device according to Embodiment 2 is configured similar to Embodiment 1 in that a pair of opposing long-side end faces of a light guide plate 118 are respectively a first light-receiving face 118A1 and a second light-receiving face 118A2. In addition, as shown in FIG. 9, a second LED substrate 125B has an arrangement portion 125B1 and abutting portions 125B2. The arrangement portion 125B1 is a section on which second LEDs 124B are arranged, and has substantially the same shape as the second LED substrate 25B of Embodiment 1. The abutting portions 125B2 are shaped so as to respectively extend, from both ends of the arrangement portion 125B1 in the long-side direction (X axis direction) of the arrangement portion 125B1, toward the first LED substrate 125A, extending to near the first LED substrate 125A. The extension direction of the abutting portions 125B2 corresponds to the short-side direction (Y axis direction) of the light guide plate 118, and the extension dimension thereof is substantially identical to the short-side direction dimension of the light guide plate 118. In addition, in the present embodiment, a white resist is formed on the surface of the second LED substrate 125B on which the second LEDs 124B are disposed upright.

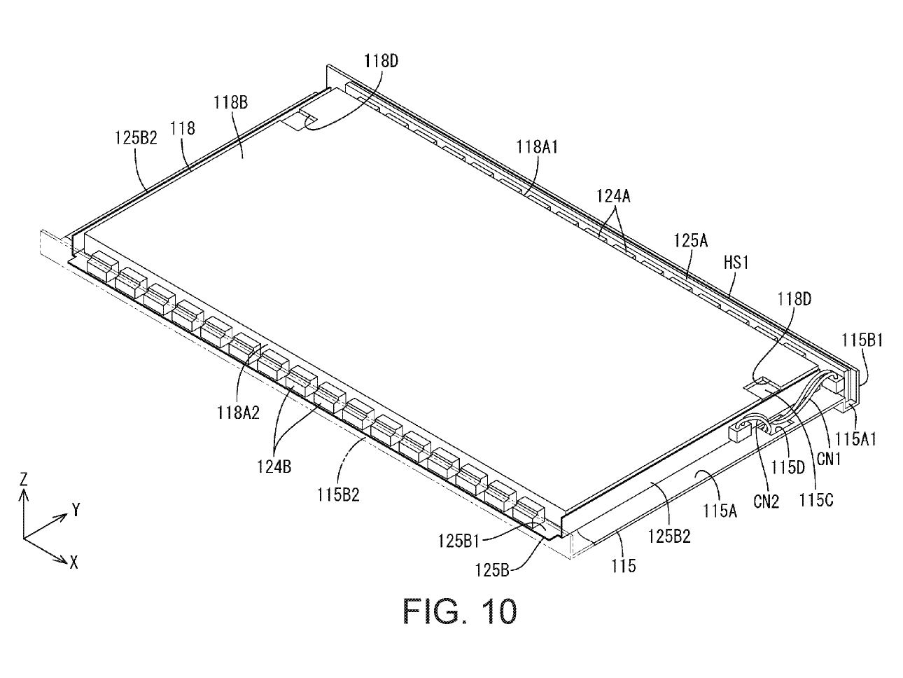

As shown in FIGS. 9 and 10, in the present embodiment, when the flexible second LED substrate 125B is attached to the light guide plate 118 during the manufacturing process, the abutting portion 125B2 is curved along a fold line (the dashed-dotted line shown on the second LED substrate 125B in FIG. 9) provided at the border between the arrangement portion 125B1 and the abutting portion 125B2 such that the abutting portion 125B2 faces a short-side end face of the light guide plate 118. By bending the abutting portions 125B2 in such a manner, the respective abutting portions 125B2 abut both short-side end faces (the end faces adjacent to the second light-receiving face 118A2) of the light guide plate 118 (the state shown in FIG. 10). As a result of such a configuration, it is possible use the respective abutting portions 125B2 to position the light guide plate 118 with respect to the second LED substrate 125B in a direction (X axis direction) orthogonal to the short-side end faces of the light guide plate 118.

In addition, in the present embodiment, the second LED substrate 125B has light-reflecting characteristics as a result of the white resist being formed on the second LED substrate 125B in the above-described manner; thus, in a state in which the respective abutting portions 125B2 abut both short-side end faces of the light guide plate 118, light that has passed through the light guide plate 118 and reached both short-side end faces of the light guide plate 118 is reflected by the respective abutting portions 125B2 and once again enters the light guide plate 118. As a result, it is possible to prevent light leakage from both short-side end faces of the light guide plate 118.

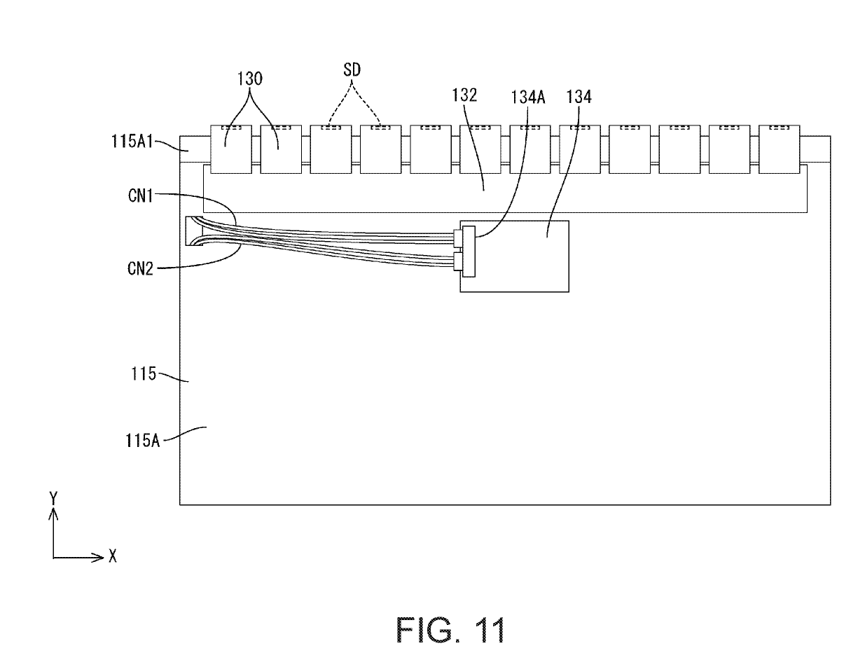

Also in the present embodiment, as shown in FIG. 9, first LED substrate-side wiring lines (one example of first wiring lines) CN1 are connected to one end of the first LED substrate 125A in the long-side direction (X axis direction) thereof, and second LED substrate-side wiring lines (one example of second wiring lines) CN2 are connected to a portion of the abutting portion 125B2 of the second LED substrate 125B. As shown in FIG. 10, the first LED substrate-side wiring lines CN1 and the second LED substrate-side wiring lines CN2 are inserted into an insertion hole 115D provided in a portion of the bottom plate 115A of the chassis 115 and are drawn out to the rear side of the bottom plate 115A. A side (another end) of the wiring lines CN1, CN2 that is opposite to the side connected to the first LED substrate 125A and the second LED substrate 125B is connected to a connection terminal 134A on an LED driving substrate (one example of a light source driving substrate) 134 disposed substantially in the center of the rear side of the bottom plate 115A (see FIG. 11). The LED driving substrate 134 provides power for driving the first LEDs 124A and the second LEDs 124B to the first LED substrate 125A and the second LED substrate 125B, and is a substrate for controlling the driving of the first LEDs 124A and the second LEDs 124B.

In the present embodiment, as shown in FIGS. 10 and 11, by having the first LED substrate-side wiring lines CN1 and the second LED substrate-side wiring lines CN2 have the above-mentioned disposition and drawing-out configuration, it is possible to have the first LED substrate-side wiring lines CN1 and the second LED substrate-side wiring lines CN2 be drawn out together to the rear surface side of the bottom plate 115A of the chassis 115 and be connected to the LED driving substrate 134. Thus, it is possible to easily draw out the wiring for driving the respective substrates 124A, 124B.

### Modification Example of Embodiment 2

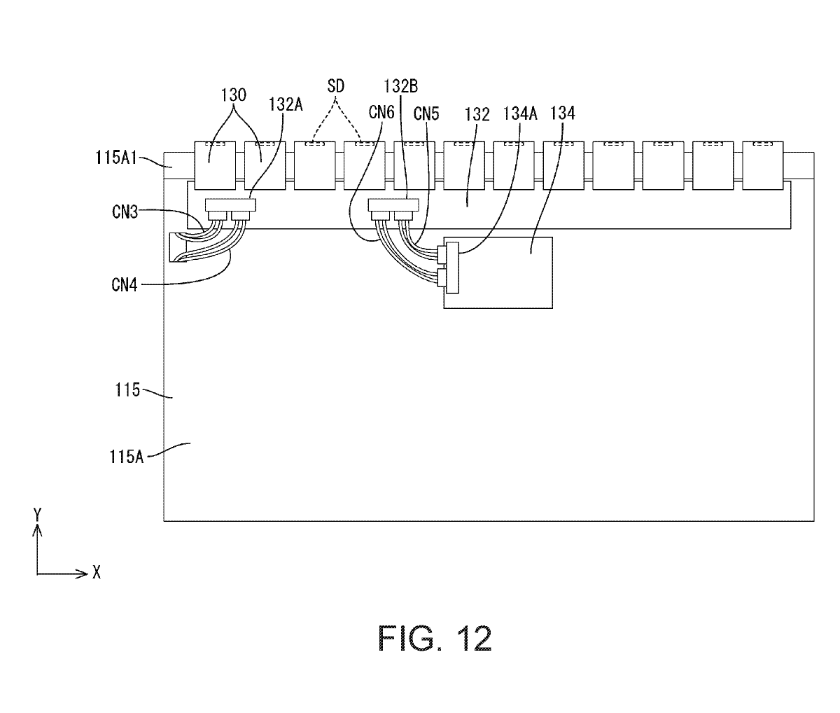

Next, a modification example of Embodiment 2 will be described with reference to FIG. 12. The present modification example differs from Embodiment 2 in that the drawing-out configuration of the second LED substrate-side wiring lines CN4, CN6 and the first LED substrate-side wiring lines CN3, CN5 on the rear surface side of the bottom plate 115A of the chassis 115 is different. As shown in FIG. 12, in the present modification example, a first source substrate-side connection terminal 132A and a second source substrate-side connection terminal 132B are provided on the rear surface side of a source substrate 132. The first source substrate-side connection terminal 132A is provided on the rear surface side of the source substrate 132 near an insertion hole in a chassis 115. The second source substrate-side connection terminal 132B is provided on the rear surface side of the source substrate 132 near the LED driving substrate 134. In addition, the first source substrate-side connection terminal 132A and the second source substrate-side connection terminal 132B are electrically connected via a wiring pattern (not shown) provided on the source substrate 132.

In the present modification example, first LED substrate-side wiring lines (one example of first wiring lines) CN3 are connected to one end of the first LED substrate in the long-side direction (X axis direction) thereof, and second LED substrate-side wiring lines (one example of second wiring lines) CN4 are connected to a portion of the abutting portion of the second LED substrate. As shown in FIG. 12, the first LED substrate-side wiring lines CN3 and the second LED substrate-side wiring lines CN4 are inserted into the insertion hole 115D provided on a portion of the bottom plate 115A of the chassis 115 and are drawn out to the rear side of the bottom plate 115A. A side of the wiring lines CN3, CN4 that is opposite to the side connected to the first LED substrate and the second LED substrate is connected to the first source substrate-side connection terminal 132A. In addition, first LED substrate-side wiring lines CN5, which are connected to the first source substrate-side connection terminal 132A via the above-mentioned wiring pattern, and second LED substrate-side wiring lines CN6, which are connected to the first source substrate-side connection terminal 132A via the above-mentioned wiring pattern, are connected to the second source substrate-side connection terminal 132B. Also, the side of these wiring lines CN5, CN6 opposite to the side connected to the second source substrate-side connection terminal 132B is connected to the connection terminal 134A of the LED driving substrate 134.

In the present modification example, as a result of the respective wiring lines CN3, CN4, CN5, CN6 having the above-described drawing-out configuration, the first LED substrate-side wiring lines CN3, CN5 and the second LED substrate-side wiring lines CN4, CN6 are connected to the LED driving substrate 134 via the source substrate 132. Thus, compared to a configuration in which the first LED substrate-side wiring lines CN3, CN5 and the second LED substrate-side wiring lines CN4, CN6 are drawn out all the way to the LED driving substrate 134, it is possible to shorten the drawn-out length of the first LED substrate-side wiring lines CN3, CN5 and the second LED substrate-side wiring lines CN4, CN6, and it is also possible to simply draw out the respective wiring lines CN3, CN4, CN5, CN6.

### Embodiment 3

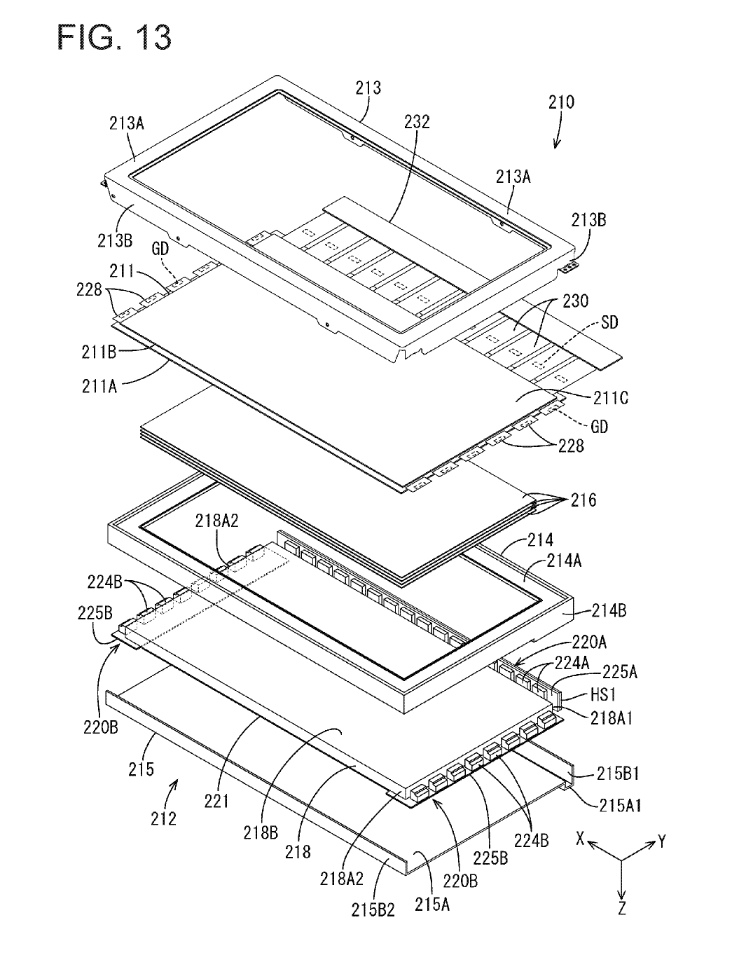

Embodiment 3 will be described with reference to the drawings. Embodiment 3 differs from Embodiment 1 in the arrangement and number of second LED units 220B. Other configurations are similar to those of Embodiment 1 and Embodiment 1, and therefore, descriptions of the configurations, operation, and effects thereof will be omitted. Parts in FIG. 13 that have 200 added to the reference characters of FIG. 2 are the same as these parts as described in Embodiment 1.

As shown in FIG. 13, in a liquid crystal display device 210 according to Embodiment 3, both short-side end faces of a light guide plate 218 are respectively second light-receiving faces 218A2, and second LED units 220B are respectively disposed on the second light-receiving face 218A2 sides of the light guide plate 218. In the respective second LED units 220B, the dimension in the long-side direction (Y axis direction) of a second LED substrate 225B and the number of second LEDs 224B have been modified from Embodiment 1 in accordance with the short-side direction (Y axis direction) dimension of the light guide plate 218. The configuration of the second LED units 220B is the same as in Embodiment 1, however. Therefore, in the respective second LED units 220B, a portion of the second LED substrate 225B is attached to an opposite surface 218C of the light guide plate 218, and contacts both the light guide plate 218 and a bottom plate 215A of a chassis 215 while being sandwiched therebetween. The number and arrangement of first LED units 220B is the same as in Embodiment 1.

In the present embodiment, by using the above-mentioned configuration, light from first LEDs 224A is received by a first light-receiving face 218A1, and light from the second LEDs 224B is received by the respective second light-receiving faces 218A2, resulting in light being received at three of the end faces of the light guide plate 218. Thus, it is possible to increase the brightness of light emitted from a light-exiting surface 218B of the light guide plate 218.

Modification examples of the respective above-mentioned embodiments are described below.

(1) In the respective above-mentioned embodiments, a configuration was used as an example in which the second LED substrate was made of a synthetic resin. However, a configuration in which the second LED substrate is made of a metal such as aluminum may also be used. Even in such a case, the second LED substrate is disposed in a horizontal orientation with respect to the bottom plate of the chassis; thus, it is possible to make the liquid crystal display device thinner.

(2) In the respective above-mentioned embodiments, a configuration was used as an example in which one or two end faces of the end faces of the light guide plate (excluding the end face facing the source substrate) were second light-receiving faces. However, a configuration in which three of the end faces (excluding the end face facing the source substrate) are all second light-receiving faces may also be used. In such a case, light is received at all of the end faces of the light guide plate; thus, it is possible to further increase the brightness of the light emitted from the light-exiting surface of the light guide plate.

(3) In the respective above-mentioned embodiments, a configuration was used as an example in which a portion of the second light source substrate was attached to the opposite surface of the light guide plate. A configuration in which a portion of the second light source substrate is not attached to the light guide plate may also be used, however, and there are no restrictions regarding the assembly configuration of the second light source substrate with respect to the light guide plate.

(4) In the respective above-mentioned embodiments, a configuration was used an example in which a positioning portion for positioning the light guide plate with respect to the bottom plate of the chassis was provided near the first light-receiving face of the light guide plate. There are no restrictions regarding the configuration of the positioning portion, however.

(5) In the respective above-mentioned embodiments, a high-resolution liquid crystal panel was used as an example. The present invention can also be applied to a display panel that does not have high resolution, however. For example, even if the liquid crystal panel is a liquid crystal panel with high color reproducibility, by applying the present invention, it is possible to make the display device thinner while ensuring a high degree of brightness and heat-dissipating characteristics.

(6) In the respective above-mentioned embodiments, an example was used of a television receiver that included a cabinet. The present invention can also be applied in a television receiver that does not include a cabinet, however.

(7) In the respective above-mentioned embodiments, an example was used of a television receiver that included a high-resolution liquid crystal panel. The present invention can also be applied in a display device other than a television receiver, however.

Respective embodiments of the present invention were described in detail above, but these are merely examples, and do not limit the scope as defined by the claims. The technical scope defined by the claims includes various modifications of the specific examples described above.

### DESCRIPTION OF REFERENCE CHARACTERS

TV television receiver
CA, CB cabinet
P power source
T tuner
S stand
10, 210 liquid crystal display device
11, 211 liquid crystal panel
12, 212 backlight device
13, 213 bezel
14, 214 frame
15, 115, 215 chassis
15A, 115A, 215A bottom plate
15A1, 115A1, 215A1 stepped portion
16, 216 optical sheet
18, 118, 218 light guide plate
20A, 220A first LED unit
20B, 120B second LED unit
21, 221 reflective sheet
24A, 124A, 224A first LED
24B, 124B, 125B second LED
25A, 125A, 225A first LED substrate
25B, 125B, 225B second LED substrate
28, 228 gate-side flexible substrate
30, 130, 230 source-side flexible substrate
32, 132, 232 source substrate
125B1 arrangement portion
125B2 abutting portion
134 LED driving substrate
CN1, CN3, CN5 first LED substrate-side wiring line
CN2, CN4, CN6 second LED substrate-side wiring line
HS1 first heat dissipation sheet
HS2 second heat dissipation sheet
GD gate driver
SD source driver

1. A display device, comprising:
a chassis having at least a bottom plate;
a display panel disposed on one surface side of the bottom plate;
a flexible substrate that is flexible and bent such that one end side thereof is connected to the display panel and another end side reaches another surface side of the bottom plate;
a signal transmission substrate that is connected to said another end side of the flexible substrate and disposed on said another surface side of the bottom plate, the signal transmission substrate transmitting signals to the flexible substrate;
a light guide plate that is disposed between the display panel and the bottom plate and that emits light toward the display panel, an end face of the light guide plate facing the flexible substrate being a first light-receiving face and at least one other end face of the light guide plate being a second light-receiving face;
first light sources of a top-emitting type disposed such that a light-emitting surface thereof faces the first light-receiving face of the light guide plate;
second light sources of a side-emitting type disposed such that a light-emitting surface thereof faces the second light-receiving face of the light guide plate;
a first light source substrate made of metal and supported by the bottom plate of the chassis, the first light sources being disposed on a surface of the first light source substrate; and
a second light source substrate supported by the bottom plate of the chassis, the second light sources being disposed on a surface of the second light source substrate.

2. The display device according to claim 1, wherein the first light sources have a higher output than the second light sources.

3. The display device according to claim 1, wherein the first light source substrate is disposed such that a portion thereof overlaps the signal transmission substrate in a direction orthogonal to the first light-receiving face.

4. The display device according to claim 1, wherein the second light source substrate is made of a flexible resin.

5. The display device according to claim 4, wherein at least a portion of the second light source substrate is attached to a surface of the light guide plate such that said portion is sandwiched between the light guide plate and the bottom plate.

6. The display device according to claim 5, wherein a positioning portion that positions the light guide plate with respect to the bottom plate is provided on an edge of the light guide plate near the first light-receiving face.

7. The display device according to claim 5, wherein a positioning portion that positions the light guide plate with respect to the first light source substrate is provided on an edge of the light guide plate near the first light-receiving face.

8. The display device according to claim 4,
wherein a pair of opposing end faces of the light guide plate are respectively the first light-receiving face and the second light-receiving face, and
wherein the second light source substrate has an abutting portion that abuts an end face of the light guide plate adjacent to the second light-receiving face, the abutting portion extending toward the first light source substrate from an end of the second light source substrate.

9. The display device according to claim 8, wherein a white resist is formed on the abutting portion.

10. The display device according to claim 8, further comprising a light source driving substrate that is disposed on said another surface side of the bottom plate and that provides driving power to the first light sources and the second light sources,
wherein a first wiring line is connected to the first light source substrate, another end of the first wiring line being connected to the light source driving substrate, and
wherein a second wiring line is connected to the abutting portion of the second light source substrate, another end of the second wiring line being connected to the light source driving substrate.

11. The display device according to claim 10, wherein the first wiring line and the second wiring line are connected to the light source driving substrate via the signal transmission substrate.

12. The display device according to claim 1,
wherein the chassis has a side wall that rises from an edge of the bottom plate toward the display panel, and
wherein the display device further includes a heat-dissipating member that contacts the first light source substrate and the side wall while being sandwiched therebetween.

13. The display device according to claim 1, further comprising a heat-dissipating member that contacts the bottom plate and the signal transmission substrate while being sandwiched therebetween.

14. The display device according to claim 1, wherein the display panel is a liquid crystal panel that uses liquid crystal.

15. A television receiver, comprising:
the display device according to claim 1.
